(19) United States
(12) Patent Application Publication
(10) Pub. No.: US 2006/0110988 A1
(43) Pub. Date: May 25, 2006

(54) Sliding module for sliding-type portable terminal

(75) Inventor: Ui-Jin Lee, Anyang-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/141,472

(22) Filed: May 31, 2005

(30) Foreign Application Priority Data
Nov. 25, 2004 (KR) 2004-97675

(51) Int. Cl. H01R 13/514

(52) U.S. Cl. 439/752

(57) ABSTRACT

A sliding module for a sliding-type portable terminal includes a main housing extending along a longitudinal direction; a sliding housing coupled to the main housing in such a manner that it can slide; a pair of side sliding modules positioned between both sides of the sliding housing and coupled to both longitudinal ends of the main housing to slide the sliding housing in a direction approaching or away from the main housing; and at least one stopper means positioned in the housing and adapted to engage or disengage, as it slides together with the housing, to limit the sliding movement of the sliding housing.

### PRIORITY

This application claims priority to an application entitled “Sliding Module for Sliding-type Portable Terminal” filed with the Korean Intellectual Property Office on Nov. 25, 2004 and assigned Serial No. 2004-97675, the contents of which are hereby incorporated by reference.

### BACKGROUND OF THE INVENTION

1. Field of the Invention

The present invention relates to a sliding module for a sliding-type portable terminal, and more particularly, to a sliding-type portable terminal having a pair of side sliding modules.

2. Description of the Related Art

A “portable communication apparatus” is an apparatus used for wireless communication. Portable communication apparatuses may be classified into various categories according to their appearance, such as bar-type terminals, flip-type terminals, and folder-type terminals. The bar-type terminals have a single housing shaped like a bar. The flip-type terminals have a flip that is rotatably coupled to a bar-shaped housing by a hinge device. The folder-type terminals have a folder connected to a single bar-shaped housing by a hinge device in such a manner that the folder can be rotated to fold onto, or unfold from, the housing.

In addition, portable communication apparatuses may be classified into rotation-type terminals and sliding-type terminals according to the way in which the terminal opens and closes. With rotation-type terminals, two housings are coupled to each other in such a manner that one housing rotates to open or close relative to the other. In sliding-type terminals, two housings are coupled to each other in such a manner that one housing slides along a longitudinal direction to open or close relative to the other. These portable communication apparatuses can be easily understood by those skilled in the art.

As shown in FIGS. 1 and 2, a conventional sliding-type portable terminal 1 includes a main body 2 having a number of keypads 2a and a microphone device 2b and a sliding body 3 adapted to slide half the length of the main body 2 upward to open, and downward to close. The main body 2 has a 3×4 keypad array. The sliding body 3 has a speaker device 3a and a display device 3b positioned on the front surface thereof.

The conventional siding-type portable terminal 1 as shown in FIG. 3 includes a main body 2, a sliding body 3 adapted to slide a predetermined distance on the main body 2, guide means 4 positioned within the main body 2 and the sliding body 3 to guide the sliding body 3 on the main body 2, and at least one coil spring 5 positioned between the sliding body 3 and the main body 2 to provide the elastic force for the upward and downward sliding movement of the sliding body 3.

The main body 2 has a plate-shaped main plate 2c and the sliding body 3 has a plate-shaped sliding plate 3c as shown in FIGS. 3 and 4.

The guide means 4 include guide ribs 4a on both sides of the plate-shaped sliding plate 3c and guide slots 4b on the plate-shaped main plate 2c to be coupled to the guide ribs 4a.

This conventional sliding-type portable terminal having a plate-shaped main plate positioned in the main body, a plate-shaped sliding plate positioned in the sliding body, and a driving spring positioned between the plates to slide the sliding body is limited in that the radius of rotation of the spring is determined by the width of the plates. As a result, the size and thickness of the plates cannot be reduced, creating an obstacle to manufacturing a compact terminal and degrades the terminal design.

Since the plates and the guide means are integrally coupled to each other, it is difficult to consider their tolerance level, and thus, determine how long they will last under normal use. Furthermore, it becomes costly to replace them if broken.

The plates and the guide means also have a large contact surface during sliding, creating noise, poor operation and increased friction, which leads to a shorter useful lifespan.

When the coil spring positioned in the plates is moved repeatedly over time, the elasticity of the spring decreases to the point of failure, making it unable to move the terminal. In addition, the stopper function of the terminal also deteriorates.

### SUMMARY OF THE INVENTION

Accordingly, the present invention has been made to solve the above-mentioned problems occurring in the prior art, and an object of the present invention is to provide a sliding module for a sliding-type portable terminal having a pair of side sliding modules for easy sliding opening/closing operation of the terminal.

Another object of the present invention is to provide a sliding module for a sliding-type portable terminal having a pair of side sliding modules to reduce the size and thickness of the terminal and achieve a compact size.

Another object of the present invention is to provide a sliding module for a sliding-type portable terminal having a pair of side sliding modules made up of a metallic material to prevent wear and tolerance problems caused by repeated sliding movement for prolonged life of the terminal, and to facilitate the replacement of worn components.

Another object of the present invention is to provide a sliding module for a sliding-type portable terminal having at least one stopper means adapted to engage or disengage, depending on the movement of the terminal, and limit the movement of the sliding housing so that the impact on the stopper during sliding movement of the terminal is dispersed to alleviate the fatigue of the stopper.

To accomplish this object, there is provided a sliding module for a sliding-type portable terminal including a main housing extending along a longitudinal direction; a sliding housing coupled to the main housing in such a manner that it can slide; a pair of side sliding modules positioned between both sides of the sliding housing and coupled to both longitudinal ends of the main housing to slide the sliding housing in a direction approaching or away from the main housing; and at least one stopper means positioned in the housing and adapted to engage or disengage, as it slides together with the housing, to limit the sliding movement of the sliding housing.

### BRIEF DESCRIPTION OF THE DRAWINGS

The above and other objects, features and advantages of the present invention will be more apparent from the following detailed description taken in conjunction with the accompanying drawings, in which:

FIG. 1 is a front view showing a conventional sliding-type portable terminal prior to operation;

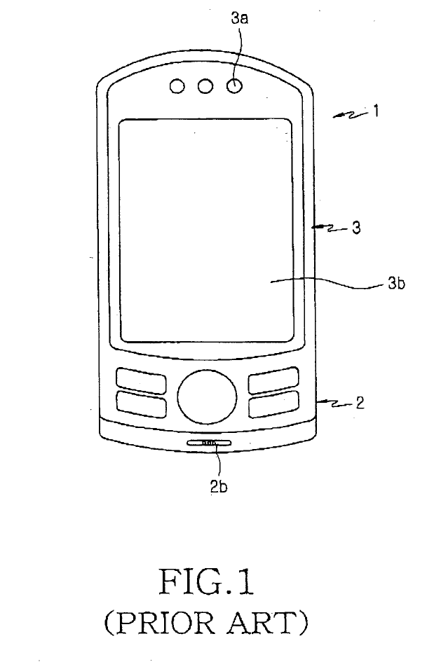

FIG. 2 is a front view showing a conventional sliding-type portable terminal of FIG. 1 after operation;

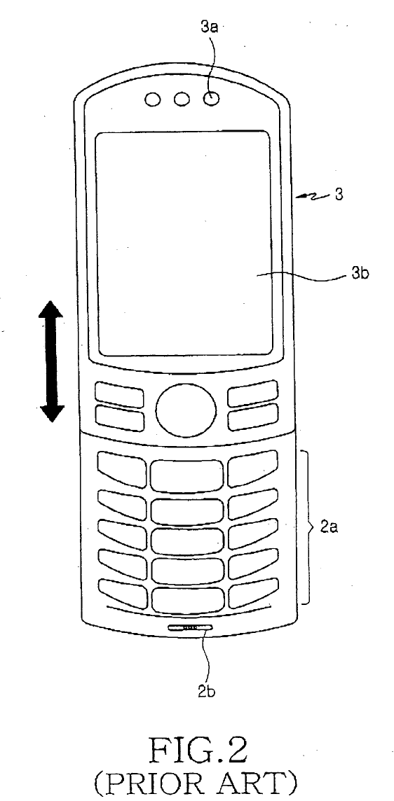

FIG. 3 is a front view showing a main plate, a sliding plate, and a driving spring among the construction of the sliding-type portable terminal shown in FIG. 1;

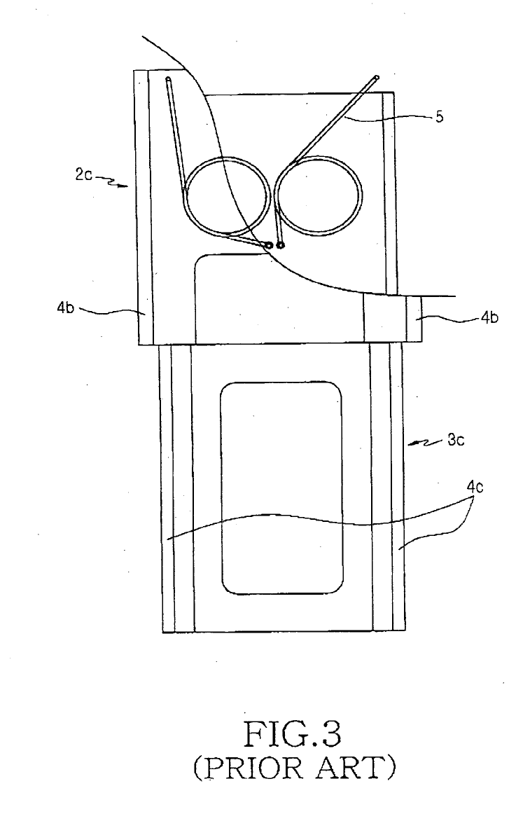

FIG. 4 is a front view showing a main plate and a sliding plate among the construction of the sliding-type portable terminal shown in FIG. 2;

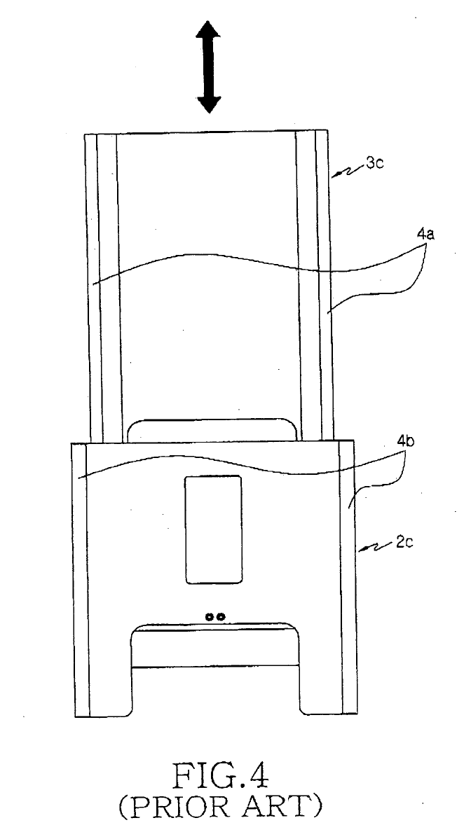

FIG. 5 is an exploded perspective view showing the construction of a sliding module for a sliding-type portable terminal according to a preferred embodiment of the present invention;

FIG. 6 is an assembled perspective view showing the construction of the sliding module of FIG. 5;

FIG. 7 is a sectional view taken along line A-A′ of FIG. 6;

FIG. 8 is a sectional view magnifying part A of FIG. 7;

FIG. 9 is a perspective view showing a sliding module for a sliding-type portable terminal, prior to operation, according to a preferred embodiment of the present invention;

FIG. 10 is a perspective view showing a guide movement groove in the construction of the sliding module of FIG. 9;

FIG. 11 is a perspective view showing a movement stop member from behind among the construction of a sliding module for a sliding-type portable terminal according to a preferred embodiment of the present invention;

FIG. 12 is a perspective view showing a sliding module for a sliding-type portable terminal, after sliding movement, according to a preferred embodiment of the present invention;

FIG. 13 is a perspective view showing a sliding module for a sliding-type portable terminal, during movement, according to a preferred embodiment of the present invention;

FIG. 14 is a perspective view showing a stopper means in the sliding module of FIG. 13;

FIG. 15 is a lateral sectional view showing a sliding module for a sliding-type portable terminal according to a preferred embodiment of the present invention;

FIG. 16 is a lateral sectional view showing an enlarged part B of FIG. 15 prior to operation of a stopper means;

FIG. 17 is a lateral sectional view showing an enlarged part B of FIG. 15 during operation of a stopper means; and

FIG. 18 is a perspective view showing a main housing and a movement stop member from behind among the construction of a sliding module for a sliding-type portable terminal according to a preferred embodiment of the present invention.

### DETAILED DESCRIPTION OF THE PREFERRED EMBODIMENT

Hereinafter, preferred embodiments of the present invention will be described with reference to the accompanying drawings. In the following description of the present invention, a detailed description of known functions and configurations incorporated herein will be omitted when it may make the subject matter of the present invention unclear.

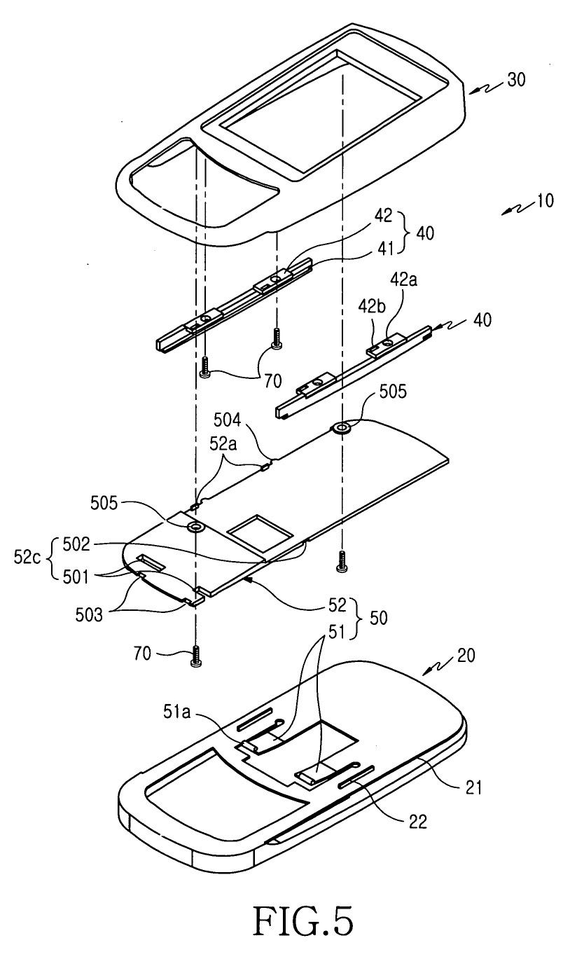

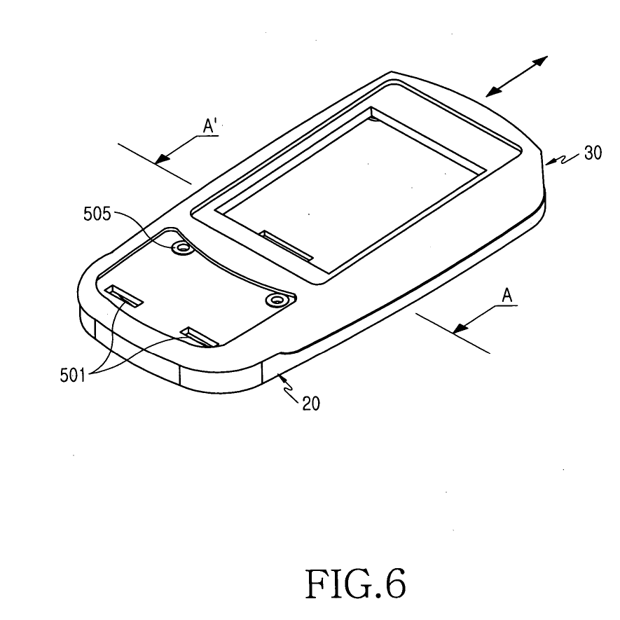

As shown in FIGS. 5 and 6, a sliding module 10 for a sliding-type portable terminal includes a main housing 20, a sliding housing 30, a pair of slide sliding modules 40, and a stopper means 50. The main housing 20 extends along a longitudinal direction so that the sliding housing 30 can slide. The sliding housing 30 is slidably coupled to the main housing 20. The pair of side sliding modules 40 are coupled to both longitudinal sides of the main housing 20 and are positioned between both sides of the sliding housing 30 so that the sliding housing 30 can slide longitudinally, up or down with respect to the main housing 20.

The stopper means 50 is positioned between the main and sliding housings 20 and 30 and is adapted to engage or disengage, as it slides together with the sliding housing 30, and limits the sliding movement of the sliding housing 30.

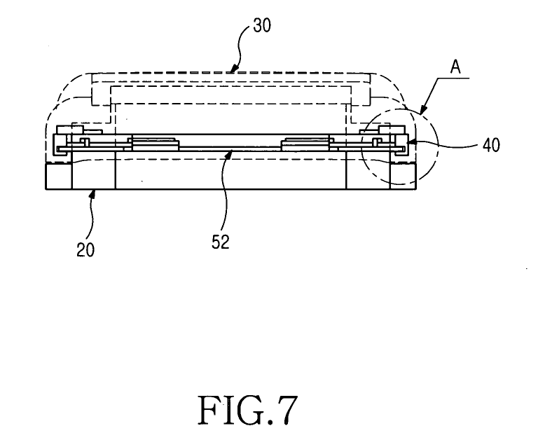

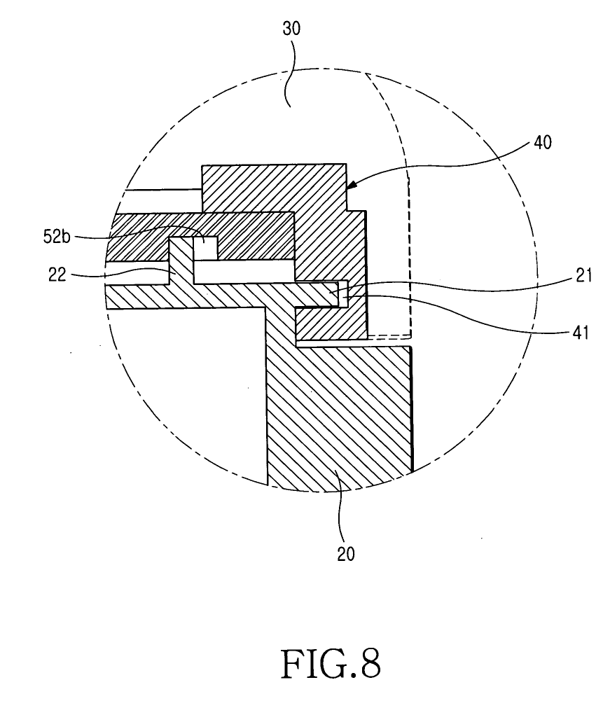

As shown in FIGS. 7 and 8, the main housing 20 has guide rails 21 formed on both ends thereof along the longitudinal direction to guide the sliding movement of the side sliding modules 40. In addition, there is at least one guide protrusion 22 formed adjacently to the guide rails 21. The protrusion 22 is coupled to the stopper means 50 and also guides the sliding movement of the side sliding modules 40.

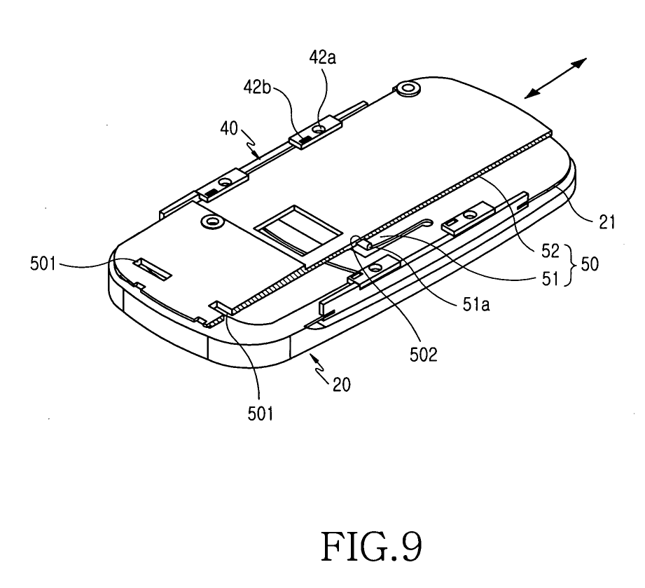

As shown in FIGS. 5 and 9, the side sliding modules 40 can be mounted within the sliding housing 30 along the longitudinal direction thereof with a number of screws 70.

As shown in FIGS. 5 and 7, the pair of side sliding modules 40 include a guide groove 41 and at least one module fastening portion 42. The guide groove 41 extends along the longitudinal direction of the sliding housing 30 and is coupled to the guide rail 21 in such a manner that it can slide along the guide rails 21. The module fastening portion 42 is formed along the guide groove 41 and is mounted on the interior of the sliding housing 30.

As shown in FIG. 9, the module fastening portion 42 has a screw hole 42a formed thereon to be fastened to the sliding housing 30 with a screw 70 and a coupling hole 42b formed adjacently to the screw hole 42a to be coupled to the coupling protrusion 52a of the stopper means 50.

As shown in FIGS. 5, 9 and 11, the stopper means 50 includes at least one hook portion 51 and a movement stop member 52. The hook portion 51 is formed on the interior of the main housing 20 and is adapted to engage or disengage the engagement means 52c (described later) of the movement stop member 52 by means of an elastic force as the sliding housing 30 slides. The movement stop member 52 is positioned on the interior of the sliding housing 30 while extending along the longitudinal direction and is adapted to engage or disengage by means of the elastic force from the hook portion 51 while traveling together with the sliding housing 30.

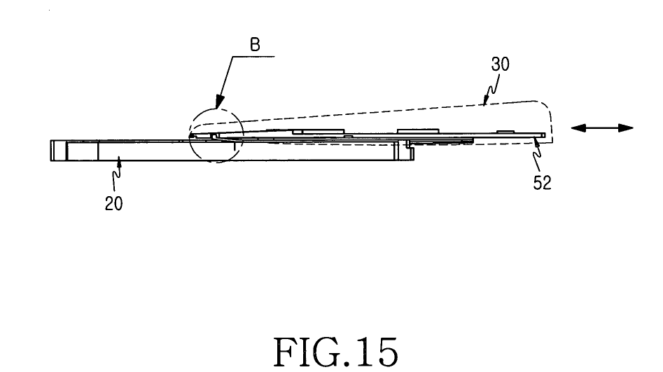

As shown in FIGS. 15, 16, and 17, the hook portion 51 is preferably made up of a leaf spring. The leaf spring 51 has an engagement protrusion 51a formed on an end thereof, which is adapted to engage and disengage the engagement holes 501 and catching grooves 502 (described later) of the engagement means 52. An end of the leaf spring is bent at a specific, predetermined angle to provide the engagement protrusion 51a with a bias, or elastic force.

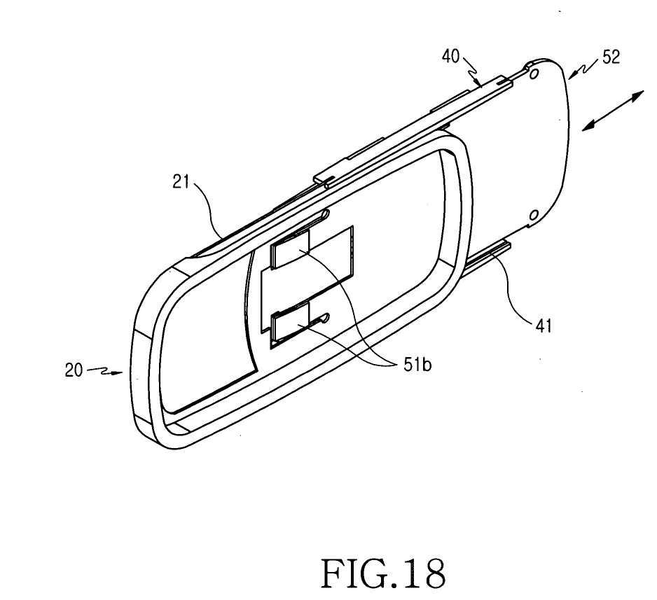

As shown in FIG. 18, the leaf spring 51 has support members 51b attached to the bottom surface thereof to support the elastic force of the leaf spring 51.

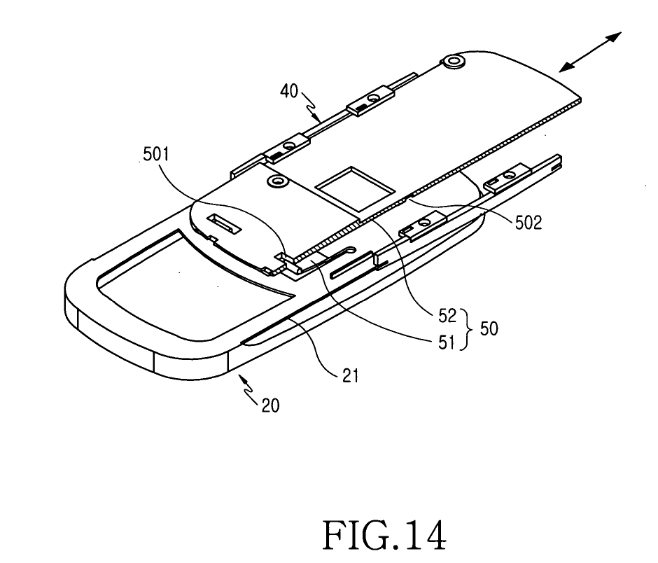

As shown in FIG. 14, the engagement protrusion 51a has a predetermined curvature so that it can engage and disengage the engagement holes 501 and the catching grooves 502 of the movement stop member 52.

As shown in FIGS. 5, 10 and 11, the movement stop member 52 includes at least one coupling protrusion 52a, at least one guide movement groove 52b, and at least one engagement means 52c. The coupling protrusion 52a is formed on the top surface of the movement stop member 52 to be coupled to the coupling hole 42b formed on the side sliding modules 40. The guide movement groove 52b is formed adjacently to the coupling protrusion 52a to be coupled to the guide protrusion 22 of the main housing 20 along the longitudinal direction and guide the sliding movement of the movement stop member 52.

As shown in FIGS. 5, 9 and 14, the engagement means 52c is positioned on the interior of the movement stop member 52 and is adapted to engage or disengage the hook portion 51 of the main housing 20 as the sliding housing 30 slides. The engagement means 52c includes a pair of engagement holes 501 and a pair of catching grooves 502.

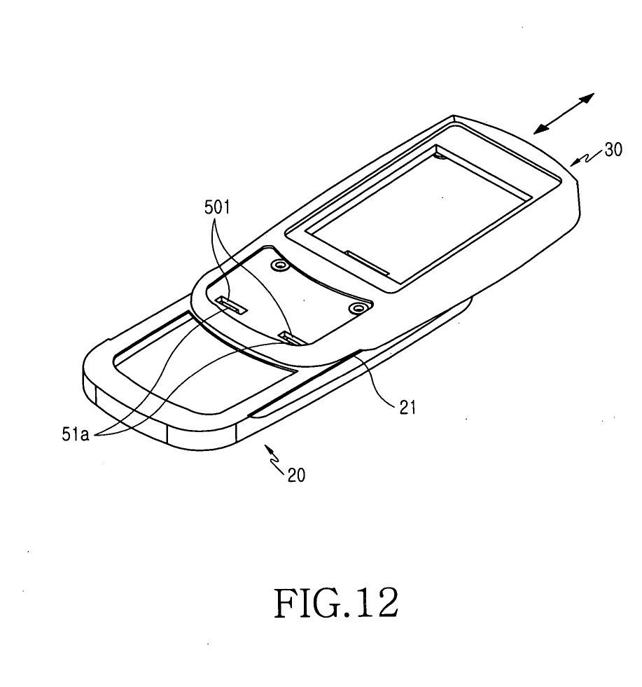

As shown in FIGS. 12, 13, 16, and 17, the engagement holes 501 are formed on the interior of the movement stop member 52 and are adapted to engage and stop the engagement protrusion 51a of the hook portion 51 when the sliding housing 30 slides away from the main housing 20.

As shown in FIGS. 5 and 6, the catching grooves 502 are formed on the interior of the movement stop member 52 so that the engagement protrusion 51a of the hook portion 51 is inserted therein and stopped when the sliding housing 30 slides downward, toward the main housing 20.

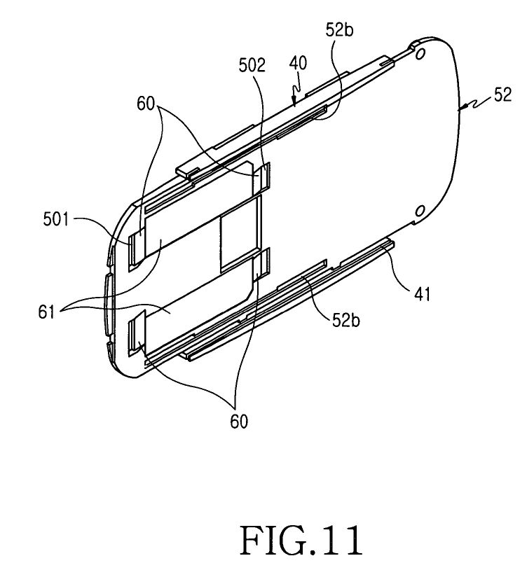

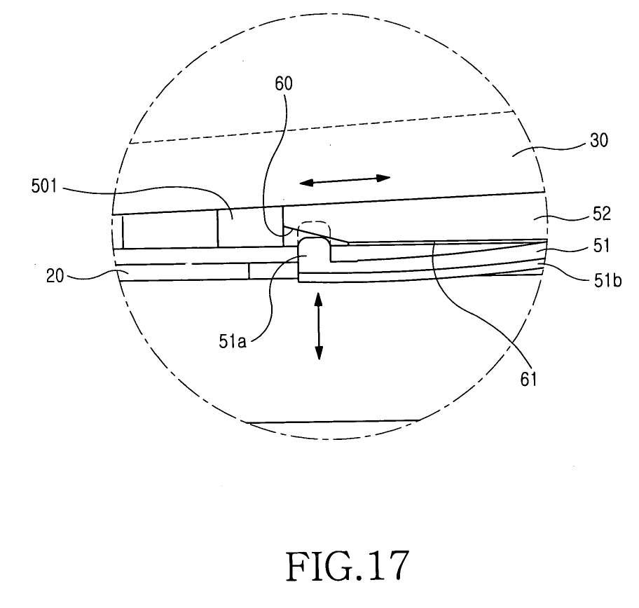

As shown in FIGS. 5 and 17, at least one guide slant surface 60 is formed adjacent to the engagement holes 501 and the catching grooves 502 to guide the hook portion 51 and a guide surface 61 is formed between the engagement holes 501, and the catching grooves 502, to guide the sliding movement of the hook portion 51. As shown in FIG. 11, the guide slant surfaces 60 are preferably symmetrical about the guide surface 61.

As shown in FIG. 5, the movement stop member 52 has a fixing portion 503 formed on an end thereof to be coupled, and fixed to, the interior of the sliding housing 30. At least one fixing protrusion 504 is formed on a side thereof to be coupled to the side sliding modules 40, and at least one screw fastening portion 505 formed on the interior thereof fastens the stop member 52 to the sliding housing 30 with a screw 70.

Operation of the sliding module for a sliding-type portable terminal according to a first embodiment of the present invention, configured as above, will now be described in more detail with reference to FIGS. 5 to 18.

As shown in FIG. 5, a pair of side sliding modules 40 are mounted between both sides of the sliding housing 30 with screws 70.

At least one module fastening portion 42 formed on the pair of side sliding modules 40 enables mounting to the interior of the sliding housing 30, preferably along its longitudinal direction.

A screw 70 is fastened to the screw hole 42a formed on the module fastening portion 42 to secure it to the sliding housing 30. The movement stop member 52 is coupled to the interior of the sliding housing 30.

As shown in FIGS. 5 and 9, the module fastening portion 42 has a coupling hole 42b formed thereon for securing to the coupling protrusion 52a on the movement stop member 52. The movement stop member 52 is mounted on the interior of the sliding housing 30 and the coupling protrusion 52a is attached to the coupling hole 42b.

The fixing portion 503 formed on an end of the movement stop member 52 is coupled to the interior of the sliding hosing 30. The movement stop member 52 has at least one fixing protrusion 504 formed on a side thereof to be coupled to the side sliding modules 40.

The movement stop member 52 has at least one screw fastening portion 505 formed on its interior to be fastened to the sliding housing 30 with a screw 70. A screw 70 is fastened to the screw fastening portion 505 to fix the movement stop member 52 to the interior of the sliding housing 30.

As shown in FIG. 6, the sliding housing 30 is coupled to the top surface of the main housing 20 in such a manner that it can slide.

As shown in FIGS. 7, 8, 9, and 10, the side sliding modules 40 are coupled to the guide rails 21 positioned on both ends of the main housing 20 in such a manner that they can slide.

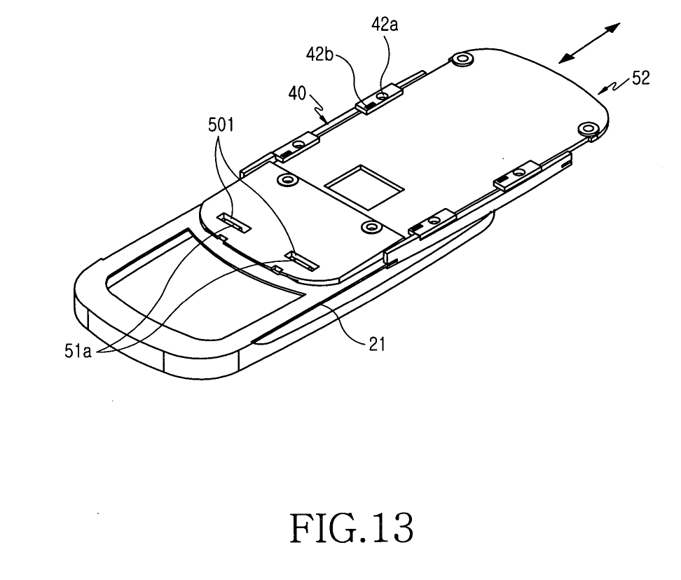

As shown in FIGS. 12 and 13, the sliding housing 30 is slid upward, away from the main housing 20 to open the terminal.

As shown in FIG. 14, the side sliding modules 40 slide along the guide rails 21 of the main housing 20.

As shown in FIGS. 5 and 11, the movement stop member 52 travels together with the sliding housing 30. The movement stop member 52 has at least one guide movement groove 52b formed thereon coupled to the guide protrusion 22 of the main housing 20 to guide the sliding movement of the movement stop member 52.

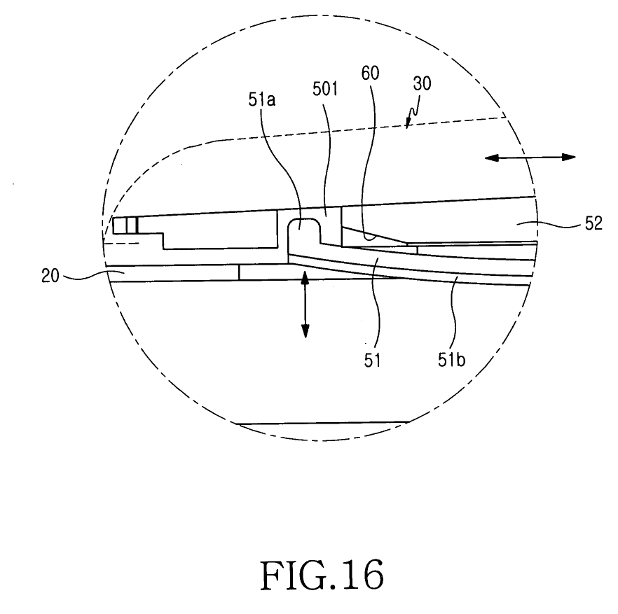

As shown in FIGS. 15 and 16, the hook portion 51 formed on the main housing 20 disengages the catching grooves 502 formed on the movement stop member 52 by means of an elastic force and is inserted into the engagement holes 501, thus limiting the sliding movement of the sliding housing 30.

The hook portion 51 is made up of a leaf spring 501 that provides an elastic force making it easier to engage and disengage the engagement holes 501 and the catching grooves 502.

As shown in FIGS. 5 and 17, at least one guide slant surface 60 is formed adjacent to the engagement holes 501 and the catching grooves 502, to guide the hook portion 51. When the hook portion 51 disengages the catching grooves 502 and slides it is guided by the guide slant surface 60. When inserted into the engagement holes 501, the hook portion 51 is guided by another guide slant surface 60 formed adjacently to the engagement holes 501.

As shown in FIGS. 11 and 17, the hook portion 51 slides on the guide surface 61, which is formed between the catching grooves 502 and the engagement holes 501, to facilitate sliding movement of the hook portion 51.

When the sliding housing 30 is moved downward, toward the main housing 20 as shown in FIG. 6, the movement stop member 52 travels together with the sliding housing 30. The sliding housing 30 and the slide sliding modules 40 again slide along the guide rails 21 to their original position.

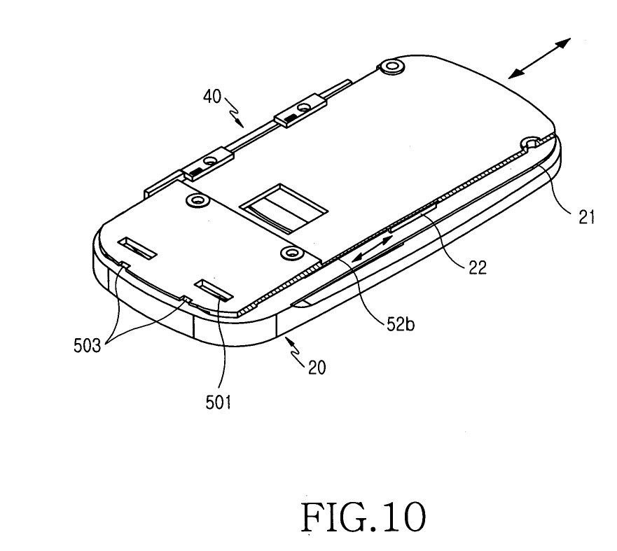

As shown in FIGS. 9 and 10, when closing the terminal, the hook portion 51 disengages the engagement holes 501 by means of an elastic force and is again inserted into the catching grooves 502. The sliding housing 30 then ceases to move.

As mentioned above, the sliding module for a sliding-type portable terminal according to the present invention has a pair of side sliding modules for easy sliding opening/closing operation of the terminal. Reduced size and thickness of the terminal makes it possible to manufacture a terminal of a compact and slim size.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A sliding module for a sliding-type portable terminal comprising:
a main housing extending along a longitudinal direction;
a sliding housing slidingly coupled to the main housing;
a pair of side sliding modules positioned between both sides of the sliding housing and coupled to both longitudinal ends of the main housing to slide the sliding housing in a direction toward or away from the main housing; and
at least one stopper means positioned in the housing and adapted to engage or disengage, as it slides together with the housing, to limit the sliding movement of the sliding housing.

2. A sliding module for a sliding-type portable terminal as claimed in claim 1, wherein the main housing has guide rails formed on both ends thereof along the longitudinal direction to guide the sliding movement of the pair of side sliding modules, and at least one guide protrusion formed adjacent to the guide rails coupled to the stopper means and guiding the sliding movement of the side sliding modules.

3. A sliding module for a sliding-type portable terminal as claimed in claim 1, wherein the side sliding modules are mounted on an interior of the sliding housing.

4. A sliding module for a sliding-type portable terminal as claimed in claim 2, wherein the pair of side sliding modules comprise:
a guide groove extending along the longitudinal direction and slidingly coupled to the guide rails; and,
at least one module fastening portion formed along the guide groove and mounted on an interior of the sliding housing.

5. A sliding module for a sliding-type portable terminal as claimed in claim 4, wherein the module fastening portion has a screw hole formed thereon for fastening to the sliding housing and a coupling hole formed thereon adjacent to the screw hole to be coupled to a coupling protrusion formed on a movement stop member of the stopper means.

6. A sliding module for a sliding-type portable terminal as claimed in claim 1, wherein the pair of side sliding modules are constructed of a metallic material.

7. A sliding module for a sliding-type portable terminal as claimed in claim 5, wherein the stopper means comprises:
at least one hook portion positioned on an interior of the main housing to provide an elastic force; and,
a movement stop member mounted on the interior of the sliding housing while extending along the longitudinal direction and adapted to engage or disengage, as it travels together with the sliding housing, by means of the elastic force from the hook portion.

8. A sliding module for a sliding-type portable terminal as claimed in claim 7, wherein the hook portion is a leaf spring, an engagement protrusion is formed on an end of the leaf spring, an end of the leaf spring is bent at a predetermined angle to provide the engagement protrusion with an elastic force, and a support member is attached to a bottom surface of the leaf spring to support the elastic force of the leaf spring.

9. A sliding module for a sliding-type portable terminal as claimed in claim 8, wherein the engagement protrusion has a predetermined curvature to engage and disengage the movement stop member.

10. A sliding module for a sliding-type portable terminal as claimed in claim 7, wherein the movement stop member comprises:
at least one coupling protrusion formed on a top surface thereof to be coupled to the coupling hole formed on the module fastening portion of the side sliding modules;
at least one guide movement groove formed adjacent to the coupling protrusion along the longitudinal direction to be coupled to a guide protrusion of the main housing and guide the sliding movement of the movement stop member; and
at least one engagement means positioned on an interior of the movement stop member to engage or disengage the hook portion of the main housing as the sliding housing slides.

11. A sliding module for a sliding-type portable terminal as claimed in claim 10, wherein the engagement means has a pair of engagement holes formed thereon to engage an engagement protrusion of the hook portion and stop it when the sliding housing slides away from the main housing and a pair of catching grooves formed thereon so that the engagement protrusion of the hook portion is inserted therein and stopped when the sliding housing slides in a direction towards the main housing.

12. A sliding module for a sliding-type portable terminal as claimed in claim 11, wherein at least one guide slant surface is formed adjacent to the engagement holes and the catching grooves to guide the hook portion; and, a guide surface is formed between the engagement holes and the catching grooves to guide the hook portion in such a manner that it can slide.

13. A sliding module for a sliding-type portable terminal as claimed in claim 12, wherein the guide slant surfaces are symmetrical about the guide surface.

14. A sliding module for a sliding-type portable terminal as claimed in claim 7, wherein the movement stop member has a fixing portion formed on an end thereof to be coupled, and fixed to, the interior of the sliding housing, at least one fixing protrusion formed on a side thereof along the longitudinal direction thereof to be coupled and fixed to the side sliding modules; and, at least one screw fastening portion formed on a interior thereof to be screw-fastened to the sliding housing.

15. A sliding module for a sliding-type portable terminal as claimed in claim 11, wherein, when the sliding housing slides away from the main housing, the side sliding modules slide along the guide rails of the main housing, the movement stop member travels together as the sliding housing travels, and the hook portion of the main housing disengages the catching grooves of the movement stop member by an elastic force and engages the engagement holes to limit the sliding movement of the sliding housing and, when the sliding housing slides in a direction towards the main housing, the sliding housing and the side sliding modules slide along the guide rails and the hook portion disengages the engagement holes by an elastic force and is again inserted into the catching grooves to stop the movement of the sliding housing.

16. A sliding module for a sliding-type portable terminal comprising:
a main housing;
a sliding housing slidingly coupled to the main housing; and
a pair of side sliding modules positioned between both sides of the housing to slide the sliding housing in a direction towards or away from the main housing.

17. A sliding module for a sliding-type portable terminal as claimed in claim 16, wherein the side sliding modules are made of a metallic material.
